(19) United States
(12) Patent Application Publication
(10) Pub. No.: US 2007/0160502 A1
(43) Pub. Date: Jul. 12, 2007

(54) MICROFLUIDIC DEVICE AND METHOD OF FABRICATING THE SAME

(75) Inventors: Kyu-youn Hwang, Yongin-si (KR); Sung-young Jeong, Yongin-si (KR); Joon-ho KIM, Yongin-si (KR); Hun-joo LEE, Yongin-si (KR); Hee-kyun LIM, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/616,148

(22) Filed: Dec. 26, 2006

(30) Foreign Application Priority Data
Dec. 26, 2005 (KR) 10-2005-0129584

(51) Int. Cl. B32B 37/12; B32B 38/04; B01L 3/00

(52) U.S. Cl. 422/100; 156/292; 156/275.7; 156/250

(57) ABSTRACT

Disclosed herein are a method of fabricating a microfluidic device, and a microfluidic device fabricated by the method. The method includes coating an adhesive material on a first substrate having a fluid port to form an adhesive layer thereon, arranging a second substrate having a microstructure formed therein with the surface of the first substrate on which the adhesive layer is formed, such that the fluid port and the microstructure correspond to each other, and heating the substrates at about 50 to about 180 degrees Celsius to bind the first substrate to the second substrate.

### CROSS-REFERENCE TO RELATED PATENT APPLICATION

This application claims priority to Korean Patent Application No. 10-2005-0129584, filed on Dec. 26, 2005, in the Korean Intellectual Property Office, and all the benefits accruing therefrom under 35 U.S.C. §119, the contents of which are incorporated herein by reference in its entirety.

### BACKGROUND OF THE INVENTION

1. Field of the Invention

The present invention relates to a method of fabricating a microfluidic device and to a microfluidic device fabricated by the method.

2. Description of the Related Art

The term “microfluidic device” refers to a device through which a small amount of fluid may flow, the device having a fluid port with an inlet and outlet connected to a microstructure, such as a microchannel or a microchamber. The device may be used as an electrochemical microsensor for chemical detection and determination. Further, the device may be used as an analytical device, such as a lab-on-a-chip, for drug screening and diagnosis.

An existing method of fabricating a microfluidic device includes forming a mixture including a binder and a precursor material on a first substrate; pre-sintering the mixture and the substrate to remove the binder from the mixture and form a consolidated first assembly; assembling the first assembly with a second assembly comprising a second substrate such that the pre-sintered mixture is positioned between the first substrate and the second assembly; and heating the assembled first assembly and second assembly to form a one-piece microstructure defining at least one recess between the first substrate and the second substrate. Further, another method for fabricating a microfluidic device includes providing a substrate having an upper face and a lower face and an electrically conducting material disposed on the upper face to form a conductor/substrate assembly; patterning a mask on the surface of the electrical conductor to form a desired arrangement of channels on the electrical conductor and to define a thickness of channel walls; etching away the part of the electrical conductor not protected by the mask to form channel walls joined to and extending from the upper face of the substrate; removing the mask; and sealing a cover plate to the tops of the channel walls to define sealed channel structures between the substrate and the cover plate, wherein the cover plate is configured to provide access to the channel structure.

However, a method of fabricating a microfluidic device including binding an upper substrate to a lower substrate using an adhesive material in a high yield and in a convenient manner is not known.

### BRIEF SUMMARY OF THE INVENTION

The present invention includes providing a method of fabricating a microfluidic device in an efficient manner.

The present invention also includes providing a microfluidic device fabricated by the method.

According to an exemplary embodiment of the present invention, a method of fabricating a microfluidic device includes coating an adhesive material on a first substrate having a fluid port to form an adhesive layer; arranging a second substrate having a microstructure formed therein with the surface of the first substrate on which the adhesive layer is formed, such that the fluid port and the microstructure correspond to each other; and heating the substrates at 50-180° C. to bind the first substrate to the second substrate.

According to another exemplary embodiment of the present invention, a microfluidic device includes a first substrate bound to a second substrate by an adhesive material, wherein the first substrate includes a fluid port and the second substrate includes a microstructure formed therein.

### BRIEF DESCRIPTION OF THE DRAWINGS

The above and other features and advantages of the present invention will become more clearly understood from the following detailed description taken in conjunction with the accompanying drawings, in which:

FIG. 1 is a schematic illustration of an exemplary embodiment of process of fabricating a microfluidic device according to the present invention;

FIG. 2 is a schematic illustration of a cross section of an exemplary embodiment of a first substrate, having fluid ports formed therein, being coated with a supporting layer and an adhesive material;

FIG. 3 is a photograph of an exemplary embodiment of a wafer surface on which a plurality of microfluidic devices formed by bonding an upper substrate to a lower substrate according to the present invention;

FIG. 4 is a photograph of one of the microfluidic devices shown in FIG. 3;

FIG. 5 includes representative scanning electron microscope (SEM) images of exemplary embodiments of surfaces obtained by cutting silicon wafer/glass substrate assemblies with a diamond wheel saw; and

FIG. 6 includes representative SEM images of exemplary embodiments of surfaces obtained by cutting silicon wafer/glass substrate assemblies with a diamond wheel saw, followed by grinding and polishing.

### DETAILED DESCRIPTION OF THE INVENTION

The present invention will now be described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, and the like may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The method of making a microfluidic device according to the present invention generally comprises coating an adhesive material on a first substrate having a fluid port to form an adhesive layer. In an exemplary embodiment of the present invention, a method of fabricating a microfluidic device includes coating an adhesive material on a first substrate having a fluid port therein to form an adhesive layer; arranging a second substrate having a microstructure formed therein with the surface of the first substrate on which the adhesive layer is formed, such that the fluid port and the microstructure correspond to (i.e., are aligned with) each other; and heating the substrates at about 50 to about 180 degrees Celsius (° C.) to bind the first substrate to the second substrate.

Formation of a fluid port on a substrate may be performed using any method, such as photolithography. The term “fluid port” generally refers to a port, which allows a microchannel or a microchamber in a microfluidic device to be in fluid communication with an external space. For example, the fluid port may be an inlet port or an outlet port. The fluid port generally has a fine diameter, and thus, a microfluidic phenomenon occurs. For example, the fluid port may have a diameter of about 0.01 millimeters (mm) to about 2 mm, but is not limited thereto. Specifically, the fluid port can have a diameter of less than or equal to about 2 mm and more specifically less than or equal to about 1 mm.

In an exemplary embodiment of the present invention, the adhesive material may be a negative photoresist material. The negative photoresist material may be a photocurable epoxy resin, such as SU-8, which is a bis-phenol A novolak resin. SU-8 is broadly used in processes of manufacturing semiconductors and commercially available from the MICROCHEM Corporation, (U.S.A.). The adhesive material may be selected from the group consisting of a fully fluorinated cyclic polymer resin, polyimide, benzocyclobutene, and a combination comprising at least one of the foregoing. The fully fluorinated cyclic polymer resin may be a cyclic transparent optical polymer, such as CYTOP, which is commercially available from ASAHI GLASS Corporation (Japan). In the present embodiment, the adhesive material is coated on an inner surface of the first substrate.

Coating of the adhesive material may be performed using any method. For example, the adhesive material may be coated on the substrate by spin coating. The spin coating method has an advantage in that the adhesive material can be uniformly and rapidly coated on the surface of the first substrate. In order to prevent the adhesive material from flowing into the fluid port, the adhesive material may be coated after closing the fluid port with a filling agent.

The first substrate may be a material selected from the group consisting of glass, silicon, metal oxides, polymers (e.g., plastics), and a combination comprising at least one of the foregoing, but is not limited thereto. In an exemplary embodiment, the first substrate may be made of a clear borosilicate glass (e.g., PYREX).

The method may further comprise laminating a supporting layer on a surface of the first substrate opposite to the surface to be coated with the adhesive material, before coating the adhesive material. The supporting layer may comprise any material, provided that it can be bound to an outer surface of the first substrate. The supporting layer may in the form of a film. In an exemplary embodiment, the supporting layer is a polymeric (plastic) or laminating tape, specifically a UV or blue tape, which is used in the process of manufacturing semiconductors. An exemplary UV film comprises polyethylene terephthalate (PET).

The supporting layer functions to close an external end of the fluid port in the first substrate such that the fluid port has a structure which is open only in an internal direction of the microfluidic device. In this case, when the adhesive material is coated on the inner surface of the first substrate of the microfluidic device, the adhesive material is not introduced into the fluid port even though the fluid port is not closed at its internal end. It is believed that this phenomenon occurs since an air pressure in the fluid port prevents the adhesive material from being introduced into the fluid port and a thickness of the adhesive material coated (for example about 20 to about 200 micrometers (μm)) is still less than a thickness of the first substrate (for example, a glass substrate with a thickness of about 0.5 to about 1 mm), but the present invention is not limited to this particular mechanism. Thus, the adhesive material may be coated without closing the fluid port and, as a result, a large amount of the adhesive material can be easily coated on the substrate. It is believed that a diameter of the port must be fine in order that the air pressure prevents the adhesive material from being introduced into the port. As stated previously, the fluid port desirably has a diameter of less than or equal to about 2 mm, specifically less than or equal to about 1 mm, with a desired range of about 0.01 mm to about 2 mm. The supporting layer functions to close an external end of the fluid port such that the substrate may be manipulated with a device operating using a vacuum, such as a spin chuck. Thus, due to the supporting layer, a large amount of substrates may be spin coated using a device such as a spin chuck. Further, since there is no need to close the fluid port during the coating of the adhesive material and the substrate may be manipulated using the spin chuck, due to the supporting layer, a substrate having a plurality of fluid port units formed in a wafer may also be manipulated.

The method may further comprise heat-treating the first substrate at a glass transition temperature of the adhesive material, after forming the adhesive layer. The glass transition temperature may vary and be adjusted depending on the type of the adhesive material used. When the adhesive material is SU-8, the glass transition temperature is about 50 to about 55° C. Due to the heat-treatment at the glass transition temperature, the adhesive material may be more uniformly coated on the first substrate.

The “second substrate having a microstructure formed therein” may be a substrate prepared using any method, including photolithography. The second substrate may be a material selected from the group consisting of glass, silicon, metal oxides, and polymers (e.g., plastics), and a combination comprising at least one of the foregoing, but is not limited thereto. The “microstructure” may be any microstructure formed within or on the microfluidic device such as microchannels, microchambers and fluidic ports. The microstructure may have a corresponding counterpart on the first substrate, for example the microchannel is formed to correspond to the fluidic port microchannel formed in the first substrate, so as to be in fluid communication with one another.

The first substrate and the second substrate may be arranged in such the corresponding position either manually or automatically using an aligner.

Heating the substrates at can be performed at about 50 to about 180° C. to bind the first substrate to the second substrate. The heating temperature and time may be adjusted depending on the type of the adhesive material selected. The heating may be performed at a single temperature or a plurality of temperatures (e.g., incremental or stepwise heating). In an exemplary embodiment of the present invention, the first substrate may be bound to the second substrate by heating the substrates at about 50 to about 55° C. for about 1 to about 10 minutes to form a weak bond between them, followed by heating at about 65 to about 95° C. for about 1 to about 10 minutes, and hard-baking them at about 65 to about 180° C. for about 1 to about 90 minutes. For example, when the adhesive material is SU-8, the first substrate and the second substrate are arranged and then weakly held together by applying a pressure to an extent that the arrangement is not broken using tweezers at about 50 to about 55° C. Then, the solvent is evaporated under a pressure of about 0 to about 10 MegaPascals (MPa) at about 95° C., and voids due to air are removed to induce a strong bond between the first substrate and the second substrate. Next, the resultant product is hard-baked at about 120° C. for about 1 hour under a pressure of about 0 to about 10 MPa to bind the substrates to each other. It should be noted that the first substrate may be bound to the second substrate with or without a pressure being applied. The pressure may be less than or equal to about 100 MPa, specifically about 1 to about 10 MPa.

The method may further comprise irradiating light having a wavelength capable of initiating photopolymerization, such as ultraviolet (UV) light, to the adhesive material, before or during the binding of the first substrate to the second substrate, when the adhesive material is a photocurable material, such as SU-8.

In an exemplary embodiment, the first substrate has at least two fluid port units formed therein and the second substrate has at least two microstructural features or units formed therein. In this case, the method may further comprise cutting each of microfluidic devices after binding the first substrate to the second substrate. The cutting may be performed using any method, including but not limited to dicing processes used in the manufacturing of semiconductors. For example, the cutting may be performed using a diamond blade.

FIG. 1 schematically illustrates an exemplary embodiment of a process of fabricating a microfluidic device according to the present invention. First, a supporting layer is laminated on a first substrate 10 having fluid ports 12. Next, an adhesive material is coated on a surface opposite to the supporting layer and the supporting layer is removed. The first substrate 10 coated with the adhesive material is treated at a glass transition temperature of the adhesive material to form a uniform adhesive layer. Then, the coated first substrate 10 is arranged with a second substrate 20 having microstructures formed therein and the substrates 10 and 20 are heated applying a pressure to bind the first substrate 10 to the second substrate 20. The resultant assembly is diced to obtain each of the microfluidic devices.

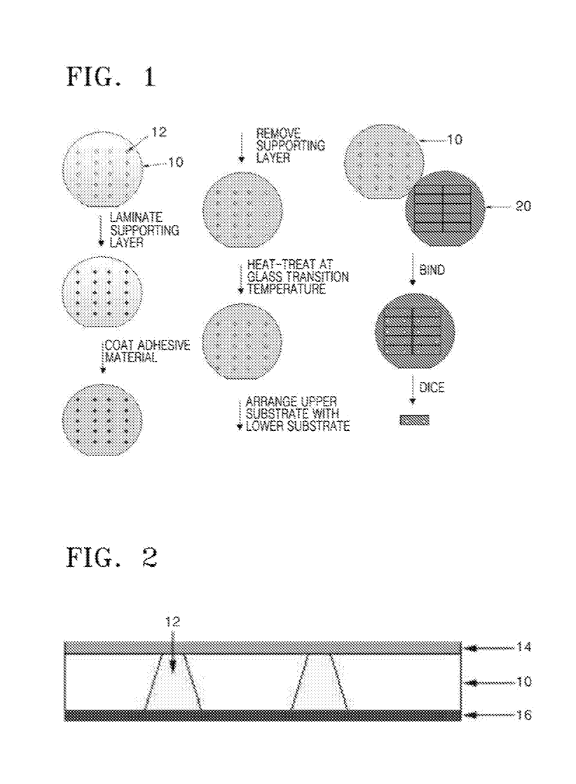

FIG. 2 is a schematic illustration of a cross section of an exemplary embodiment of a first substrate 10 having fluid ports 12 formed therein, the first substrate 10 being coated with a supporting layer 16 and an adhesive material 14. The first substrate 10 may be, for example, a glass wafer having a thickness of about 500 to about 1000 μm and the adhesive material may be SU-8 having a thickness of about 5 to about 20 μm. Further, the supporting layer 16 may be a UV or blue tape. The diameter of the fluid port 12 in the side of SU-8 layer formed on the first substrate 10 may be about 350 μm, for example, after being subject to a sand blasting process, and the diameter of the fluid port 12 in the side of the supporting layer 16 may be about 1000 μm, but the diameters are not limited thereto.

Therefore, the microfluidic device generally includes a first substrate bound to a second substrate by an adhesive material, the first substrate having a fluid port and the second substrate having a corresponding microstructure formed therein.

As stated above, the adhesive material may be a negative photoresist material. The negative photoresist material may be selected from the group consisting of a photocurable epoxy resin, a fully fluorinated cyclic polymer resin, a polyimide, a benzocyclobutene, and a combination comprising at least one of the foregoing.

Hereinafter, the present invention will be described in more detail with reference to the following examples. However, these examples are given for the purpose of illustration and are not to be construed as limiting the scope of the invention.

### EXAMPLES

### Example 1

### Fabrication of a Microfluidic Device for Cell Binding Using a Method According to an Embodiment of the Present Invention

(1) Preparation of a Lower (Second) Substrate

A lower substrate which had microchannels and microchambers patterned on a 4 inch silicon wafer having a thickness of about 500 μm using a photolithographic method was coated with octadecyltriethylammonium chloride by a dipping method. Then, the substrate was washed with a piranha solution (sulfuric acid and hydrogen peroxide mixture) for 20 minutes and then, with distilled water for 10 minutes.

(2) Preparation of an Upper (First) Substrate

A plurality of inlet and outlet port units having a diameter of about 1 mm were formed in a 4 inch PYREX glass having a thickness of about 1 mm using a sand blasting method. Then, a blue tape was laminated to a thickness of several tens of micrometers on a first surface, which was opposite to the surface on which SU-8 would be coated. The surface opposite to the blue tape, i.e., the surface to be bound with the lower substrate, was spin coated with SU-8 2500 (available from MICROCHEM Corporation, U.S.A.) at 3000 revolutions per minute (rpm) to form a SU-8 layer with a thickness of about 5 μm. The blue tape was removed from the substrate. Then, the glass substrate was placed on a hot plate at about 55° C., which is a glass transition temperature of SU-8 (50-55° C.), and heat-treated at the temperature for 1 hour.

(3) Arrangement and Binding of the Upper and Lower Substrates

The upper substrate and the lower substrate prepared as above were arranged such that the fluid ports of the upper substrate correspond to the patterns of the lower substrate. Then, the upper and lower substrates were reacted on a hot plate at about 55° C. for about 5 minutes using tweezers to induce a weak bond between them.

Next, the upper and lower substrates were pressed using the tweezers on a hot plate at about 95° C. for about 10 minutes to induce a strong bond between them. During this process, the solvent was evaporated and the trapped air was removed.

Then, an excess amount of i-line light was irradiated through the upper substrate to the SU-8 layer for about 2 to about 3 minutes to induce complete crosslinking of the SU-8.

The bound substrates were hard-baked at about 120° C. for about 10 minutes under a pressure of about 10 kiloPascals (KPa) and cooled to room temperature. Then, the individual microfluidic devices were diced using a diamond blade.

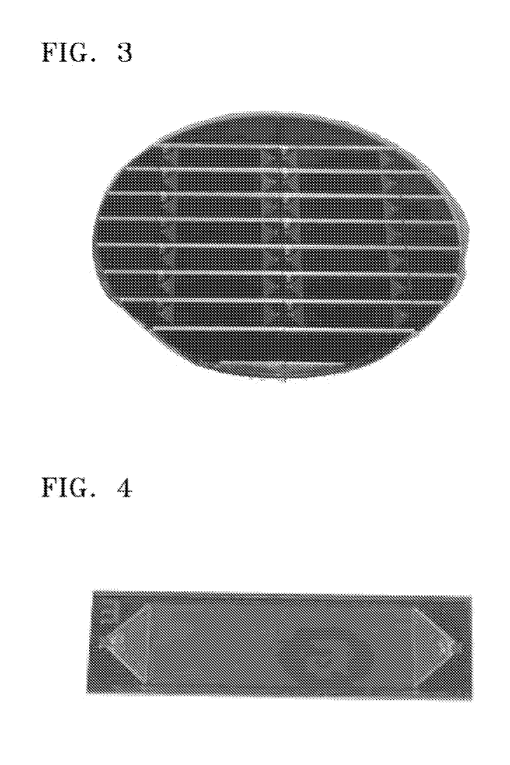

FIG. 3 is a photograph illustrating a wafer surface on which a plurality of microfluidic devices formed by bonding an upper substrate to a lower substrate are present. Referring to FIG. 3, a plurality of microfluidic devices may be manipulated in a wafer unit according to an exemplary embodiment of the present invention. In the example, four silicon wafer/glass substrate assemblies were manufactured. When they were examined visually, regions in which the wafer and the glass substrate were not bound to each other could not be found. In addition, when the silicon wafer/glass substrate assemblies were placed on a hot plate at about 95° C. and water drops were added to the fluid ports, bubbles were formed. This means that each of the fluid ports and the microchannels was not clogged during the coating of SU-8 2005 without a special treatment.

FIG. 4 is a photograph of view illustrating one of microfluidic devices obtained by dicing the plurality of microfluidic devices of FIG. 3. During the dicing, separation of the silicon wafer from the glass substrate was not observed. This means that the bonding strength between the silicon wafer and the glass substrate in the assembly is strong enough to provide each of the microfluidic devices by dicing.

FIG. 5 includes scanning electron microscope (SEM) images of representative surfaces obtained by cutting the silicon wafer/glass substrate assemblies prepared in the example of the present invention with a diamond wheel saw. Referring to FIG. 5, it was confirmed that the silicon wafer was firmly and well bound to the glass substrate through the SU-8.

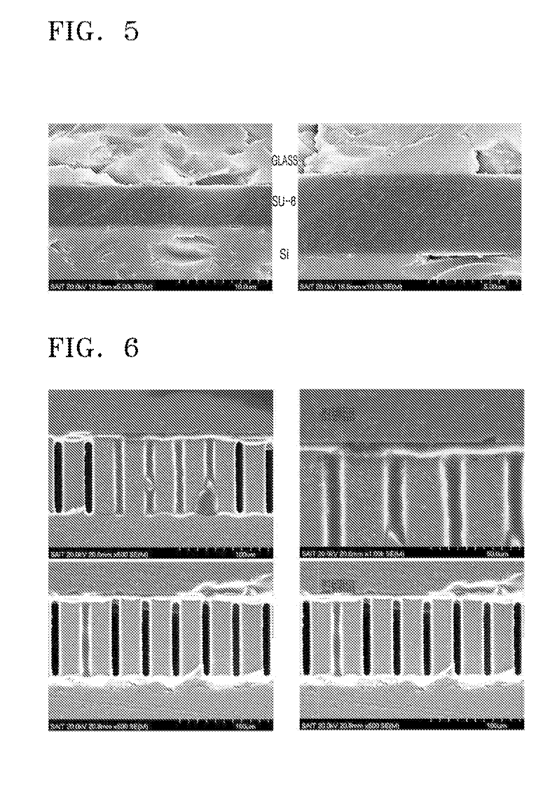

FIG. 6 illustrates representative SEM images of surfaces obtained by cutting silicon wafer/glass substrate assemblies prepared in the example of the present invention with a diamond wheel saw, followed by grinding and polishing. Referring to FIG. 6, silicon pillar heads formed on the silicon substrate are firmly bound to the glass substrate through SU-8.

According to the present invention, a microfluidic device having two substrates stably bound to each other may be fabricated in wafer units with high efficiency on a commercial scale. Furthermore, The two substrates are stably and strongly bound to each other and when a fluid flows in the device, the fluid does not leak from the device.

Although the present invention has been described herein with reference to foregoing exemplary embodiments, these exemplary embodiments do not serve to limit the scope of the present invention. Accordingly, those skilled in the art to which the present invention pertains will appreciate that various modifications are possible, without departing from the spirit and scope of the present invention as defined by the following claims.

What is claimed is:

1. A method of fabricating a microfluidic device, comprising:
coating an adhesive material on a first substrate having a fluid port to form an adhesive layer thereon;
arranging a second substrate having a microstructure formed therein with the surface of the first substrate on which the adhesive layer is formed, such that the fluid port and the microstructure correspond to each other; and
heating the substrates at about 50 degrees Celsius to about 180 degrees Celsius to bind the first substrate to the second substrate.

2. The method of claim 1, further comprising laminating a supporting layer on a surface of the first substrate opposite to the surface to be coated with the adhesive material, before coating the adhesive material on the first substrate.

3. The method of claim 2, wherein the supporting layer is a UV tape or blue tape.

4. The method of claim 1, wherein the adhesive material is a negative photoresist material.

5. The method of claim 1, wherein the adhesive material is selected from the group consisting of a photocurable epoxy resin, a fully fluorinated cyclic polymer resin, a polyimide, a benzocyclobutene, and a combination comprising at least one of the foregoing.

6. The method of claim 5, wherein the photocurable epoxy resin is a bis-phenol A novolak resin.

7. The method of claim 5, wherein the fully fluorinated cyclic polymer resin is a cyclic transparent optical polymer.

8. The method of claim 1, wherein the fluid port has a diameter of less than or equal to about 2 millimeters.

9. The method of claim 1, further comprising heat-treating the first substrate at a glass transition temperature of the adhesive material, after forming the adhesive layer.

10. The method of claim 9, wherein the glass transition temperature is about 50 degrees Celsius to about 55 degrees Celsius.

11. The method of claim 1, wherein heating the substrates comprises incrementally heating the substrates.

12. The method of claim 11, wherein incrementally heating the substrates comprises heating the first substrate and the second substrate at about 65 degrees Celsius to about 95 degrees Celsius for about 1 minute to about 10 minutes and heating the first substrate and the second substrate at about 65 degrees Celsius to about 180 degrees Celsius for about 1 minute to about 90 minutes.

13. The method of claim 1, wherein the binding of the first substrate to the second substrate is performed with a pressure being applied to the first substrate and the second substrate.

14. The method of claim 13, wherein the pressure is about 1 megaPascal to about 10 megaPascals.

15. The method of claim 1, further comprising curing the adhesive material by irradiating the adhesive material with light, either before or during the binding of the first substrate to the second substrate.

16. The method of claim 1, wherein each of the first substrate and the second substrate is selected from the group consisting of glass, silicon, metal oxides, polymers, and a combination comprising at least one of the foregoing materials.

17. The method of claim 1, wherein the first substrate comprises at least two fluid ports and the second substrate comprises at least two microstructural units formed therein.

18. The method of claim 17, wherein each of the at least two fluid ports in the first substrate and each of the at least two microstructural units in the second substrate form individual microfluidic device.

19. The method of claim 18, further comprising cutting each of microfluidic devices to provide discrete microfluidic devices.

20. A microfluidic device having a first substrate bound to a second substrate via an adhesive material, wherein the first substrate comprises a fluid port and the second substrate comprises a microstructural unit formed therein.

21. The microfluidic device of claim 20, wherein the adhesive material is a negative photoresist material.

22. The microfluidic device of claim 20, wherein the adhesive material is selected from the group consisting of a photocurable epoxy resin, a fully fluorinated cyclic polymer resin, a polyimide, a benzocyclobutene, and a combination comprising at least one of the foregoing.

23. The microfluidic device of claim 22, wherein the photocurable epoxy resin is a bis-phenol A novolak resin.

24. The microfluidic device of claim 22, wherein the fully fluorinated cyclic polymer resin is a cyclic transparent optical polymer.
